(19) United States
(12) Patent Application Publication
(10) Pub. No.: US 2005/0227666 A1
(43) Pub. Date: Oct. 13, 2005

(54) METHOD OF ACCESSING EMERGENCY NUMBERS FOR MOBILE STATION USERS

(76) Inventor: Steven D. Cheng, San Diego, CA (US)

Correspondence Address: NORTH AMERICA INTELLECTUAL PROPERTY CORPORATION, P.O. BOX 506, MERRIFIELD, VA, 22116, US

(21) Appl. No.: 10/708,873

(22) Filed: Mar. 30, 2004

(51) Int. Cl. H04Q 7/20

(52) U.S. Cl. 455/404.1; 455/403

(57) ABSTRACT

A method of dialing a local emergency telephone number using a mobile station. The mobile station has a database containing a plurality of Local Emergency CAII Numbers (LECAN) corresponding to a specific geographic location, the method includes displaying a list of local emergency services for the current geographic location, selecting one of the local emergency services, and retrieving a first local emergency telephone number associated with the selected local emergency service. The priority of the mobile station connecting to a mobile phone network is then upgraded from basic telephone call priority to emergency telephone call priority and a first telephone connection is made with the first local emergency telephone number using the emergency telephone call priority.

### BACKGROUND OF INVENTION

1. Field of the Invention

The present invention relates to making an emergency call with a mobile station, and more specifically, to a method for connecting to a local emergency telephone number using emergency telephone call priority.

2. Description of the Prior Art

There are two types of phone calls made with mobile stations: basic calls and emergency calls. When mobile stations are used to call an emergency call number such as 9-1-1, the phone calls are given emergency call priority due to the important nature of the phone call. On the other hand, for basic phone calls that deal with emergency issues, but that are note made using the emergency call number such as 9-1-1, the phone calls will not be treated as higher priority calls. This issue can be partially resolved if the mobile users subscribe to a high priority call service. Unfortunately, a significant number of mobile users do not subscribe to a high priority call service and some network operators do not provide this kind of service.

For people who are using the emergency call number such as 9-1-1 to make a phone call, sometimes they experience a long waiting time problem due to the high volume of emergency calls coming in at the same time. Thus, mobile users may decide to use local emergency phone numbers to reach emergency service providers instead of using a national emergency call number such as 9-1-1. However, in some scenarios, mobile users can experience another significant amount of waiting time to get connected to the service provider due to a large volume of phone calls camping on the base station with same type of access class control value. In other words, phone calls to the local emergency phone numbers cannot get through during heavy usage because the phone calls have the same priority as all other calls. The local emergency numbers are treated as basic calls, but they are just as critical as the 9-1-1 calls because some of them may be used to deal with life and death situations.

### SUMMARY OF INVENTION

It is therefore an objective of the claimed invention to raise the priority of basic calls made to high priority call numbers to have emergency telephone call priority in order to solve the above-mentioned problems.

According to the claimed invention, a method of dialing a local emergency telephone number using a mobile station is proposed. The mobile station has a database containing a plurality of Local Emergency CAII Numbers (LECAN) corresponding to a specific geographic location, the method includes displaying a list of local emergency services for the current geographic location, selecting one of the local emergency services, and retrieving a first local emergency telephone number associated with the selected local emergency service. The priority of the mobile station connecting to a mobile phone network is then upgraded from basic telephone call priority to emergency telephone call priority and a first telephone connection is made with the first local emergency telephone number using the emergency telephone call priority.

According to the claimed invention, a method of upgrading priority of a local emergency call made with a mobile station is proposed. The mobile station has a LECAN database corresponding to a specific geographic location. The method includes dialing a local emergency telephone number with the mobile station, and a mobile phone network verifying that dialed local emergency telephone number is part of the LECAN database of the current geographic location. If the dialed local emergency telephone number is located in the LECAN database of the current geographic location, priority of the mobile station connecting to a mobile phone network is upgraded from basic telephone call priority to emergency telephone call priority. A telephone connection is then made with the local emergency telephone number using the emergency telephone call priority.

It is an advantage of the claimed invention that emergency telephone call priority can be given to calls made to local emergency telephone numbers if the local emergency telephone number is part of the LECAN database. This allows users to bypass national emergency call centers that may be experiencing heavy call loads while at the same time receiving emergency telephone call priority for the emergency phone calls.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a functional block diagram of a mobile station according to the present invention.

FIG. 2 is a table showing contents of the LECAN database according to the present invention.

FIG. 3 is a diagram illustrating layout of a LECAN display screen.

FIG. 4 is a diagram illustrating multiple matches for each service listed in the LECAN database.

FIG. 5 is a flowchart illustrating connecting to local emergency services using speed dialing according to the present invention.

FIG. 6 is a flowchart illustrating building and updating the Home LECAN and the Visiting LECAN according to the present invention.

FIG. 7 is a flowchart illustrating upgrading priority of a call to a manually dialed telephone number according to the present invention.

### DETAILED DESCRIPTION

The main problem with contacting a national emergency call center during an emergency is that the national emergency call centers may become overwhelmed with a high volume of calls during a short period of time. Therefore, the present invention utilizes a Local Emergency CAII Numbers (LECAN) database to give mobile station users more options for contacting emergency services. The LECAN database contains a list of local phone numbers for emergency services of a particular geographic location. When the mobile user travels from one location to another, the user can update the LECAN database stored in the mobile station to contain emergency phone numbers corresponding to the new location.

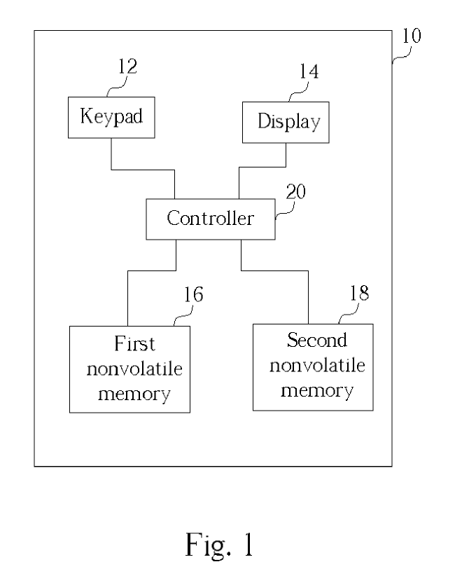

Please refer to FIG. 1. FIG. 1 is a functional block diagram of a mobile station 10 according to the present invention. The mobile station 10 contains a keypad 12 for entering commands and phone numbers and a display 14 such as an LCD for displaying data. A first nonvolatile memory 16 is used for storing a local LECAN database. A second nonvolatile memory 18 can be used for storing a global LECAN database. The first nonvolatile memory 16 and the second nonvolatile memory 18 are preferably made from flash memory, and can either be located inside a Subscriber Identity Module (SIM) card of the mobile station 10 or located outside the SIM card as dedicated memory of the mobile station 10. A controller 20 is used for controlling operation of the mobile station 10.

Instead of relying only on emergency calls to a unified calling number (or a national emergency call center) such as 9-1-1, the present invention uses basic calls for contacting emergency services. Compared with basic calls, emergency calls using the unified calling number such as 9-1-1 are connected using a different network setup. During cell camping, the emergency calls can camp almost on any cell, but the basic calls can only camp on a very limited number of cells. In addition, no SIM card is required for the emergency calls during location registration. During the mobility management, the emergency calls will use the emergency call setup that provides a better handover feature. During the teleservice setup, the emergency call has its own setup option that will route phone calls to the nearest emergency call center.

Assume a person has some serious medical problem and wants to consult a local doctor or emergency room and this person is aware of the phone number of the emergency service provider. Most of the time, this person may not like to have the phone call routed to the national emergency call center. Thus, the teleservice setup using the emergency call option will not be needed. Since this person uses the basic call service to make a phone call, the use of a SIM card is mandatory. Now, the issue is how to allow a person to use the camping option given to the emergency calls to process emergency calls made with the mobile station 10 to a local phone number using the basic call service. Assume that the priority call service is not available to this person.

The solution proposed by the present invention is to store the LECAN database inside the first nonvolatile memory 16 of the mobile station 10. The LECAN database is managed by network operators or carriers. After the user specifies a phone number to call, the phone number will be compared with the LECAN database to see whether the current phone number is a local emergency phone number. If the phone number is contained in the LECAN database, the protocol stack inside the mobile station 10 will use the emergency call setup procedure to connect the network. This phone call uses the emergency camping approach to camp efficiently on a cell. When a base station prepares the teleservice for this phone call, the base station will use the basic call option rather than the emergency call option to setup the teleservice, so the phone call will be routed to the special emergency service provider rather than the national emergency center. The carriers will also compare the phone number to the contents of the LECAN database to see whether there is any inconsistency. If the phone number is not found in the LECAN database, the call will be rejected and an attempt at fraud will be reported to the national security management center.

The Global System for Mobile communications (GSM) protocol and the Code Division Multiple Access (CDMA) protocol each have different approaches for handling emergency call cell camping. The GSM protocol uses the SIM card of the mobile station 10 to record the subscription privilege. The access control classes provided by the SIM card are used to decide whether the current cell can be camped on for the basic call, for the emergency call, or for others. The access control classes range from 0 to 15. The access control classes from 0 to 9 are designed for the basic calls, so the mobile users can be partitioned into 10 groups randomly. For the emergency camping, the cell uses an EC bit in a “cell_bar_access” attribute inside the system information message to indicate whether the current cell allows all mobile stations to camp on the current cell as an emergency call or if only emergency calls from mobile stations with access control classes from 11 to 15 can camp on it. In addition, access control class 10 is used to indicate whether network access for emergency calls is allowed for mobile stations 10 with access classes 0 to 9 or without an International Mobile Subscriber Identity (IMSI). On the other hand, some CDMA systems use the Preferred Roaming List (PRL) approach to partition mobile users into different groups. Cell camping for basic calls is decided by the PRL. The emergency calls can camp on any cell without PRL constraint.

One issue that is raised when the priority of basic phone calls is raised from basic telephone call priority to emergency telephone call priority is the cost of upgrading the priority. The emergency calls using the national emergency calling number such as 9-1-1 are made toll-free and a special government fund covers this cost. The cost for making the emergency calls using the non-national emergency calling numbers is paid by the mobile users. The extra cost for upgrading the phone call from the basic telephone call priority to the emergency telephone call priority during the camping can be either billed to the mobile users or billed to the emergency call center, and the cost is very limited.

Then again, the cost can also be covered by the same fund used for the national emergency calls. The national emergency call centers usually experience a large volume of calls at the same time. The simple way to alleviate this heavy traffic problem is to ask the emergency call users to use other phone numbers to connect to the emergency service providers such as local police and fire stations. By reducing part of the traffic, the average waiting time for the national emergency calls will be cut down dramatically. Because of this improvement, the extras cost for upgrading the phone call from the basic telephone call priority to the emergency telephone call priority for emergency use only should be covered by the same fund used for the national emergency calls.

The present invention method will allow mobile users to use emergency telephone call priority to make emergency phone calls while not encountering the long waiting time that is associated with calling national emergency call centers. International users will also benefit from the present invention. The national emergency call number such as 9-1-1 used in the United States and 1-1-2 used in parts of Europe is not designed for international mobile users. Moreover, some countries still do not provide the national emergency call services. The present invention method will automatically update the LECAN database used in the mobile station 10, and will make emergency call numbers transparent to the user of the mobile station 10. As will be discussed below, the present invention method eliminates the traditional limitations on international users when making emergency phone calls.

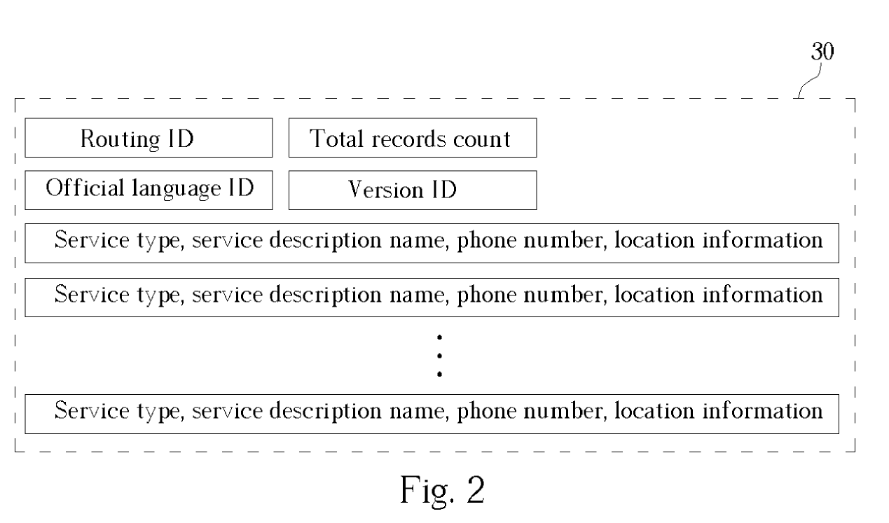

Please refer to FIG. 2. FIG. 2 is a table 30 showing contents of the LECAN database according to the present invention. The LECAN database contains a set of records for emergency services and other information services. Each record contains a service type, a service description name, a phone number, and location information. Each LECAN database has a local identification called a Routing ID. The Routing ID can be derived from the Mobile Country Code (MCC), the Mobile Network Code (MNC), the Location Area Code (LAC), and the Routing Area Code (RAC) of the mobile station 10. In addition, an official language ID can be used for each specific geographical location, or according to the home country of the mobile user. A list of the total number of records is also shown in the table 30 of FIG. 2, along with a version ID number of the LECAN database.

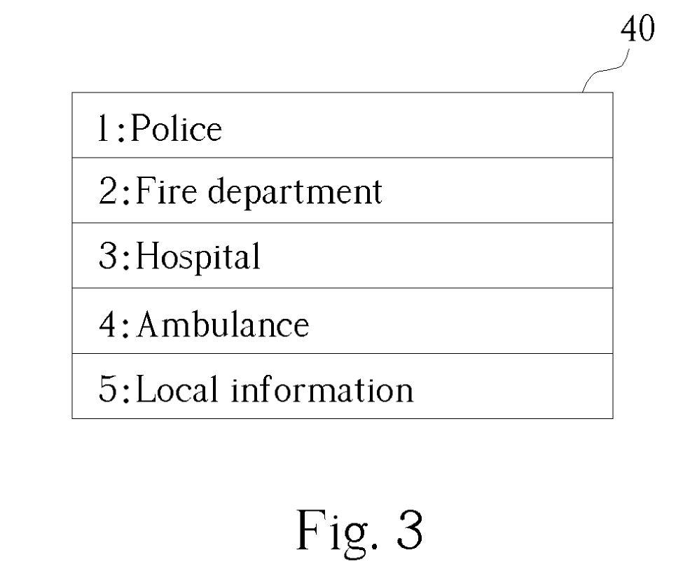

Please refer to FIG. 3. FIG. 3 is a diagram illustrating layout of a LECAN display screen 40. The type of services included in the LECAN database is specified and managed by a standards committee. The services listed in the LECAN database may include a local police station, a local fire department, a local hospital, an ambulance, driving directions, local information (411) services, etc. The LECAN database can be appended into system messages broadcast by the base stations for transmission to mobile stations in the area. As shown in FIG. 3, each service in the LECAN display screen 40 has a corresponding display ordering number associated with it. When the LECAN display screen 40 is displayed on the display 14 of the mobile station 10, only the emergency service provider names will be displayed, so the users can either use the cursor or can enter the display ordering number to trigger the local emergency call. This kind of speed dialing will make the transition from the national emergency call dialing to the local emergency call dialing transparent to the mobile users. That is, only the type of service needs to be chosen when using the speed dialing, and no phone numbers need to be manually entered.

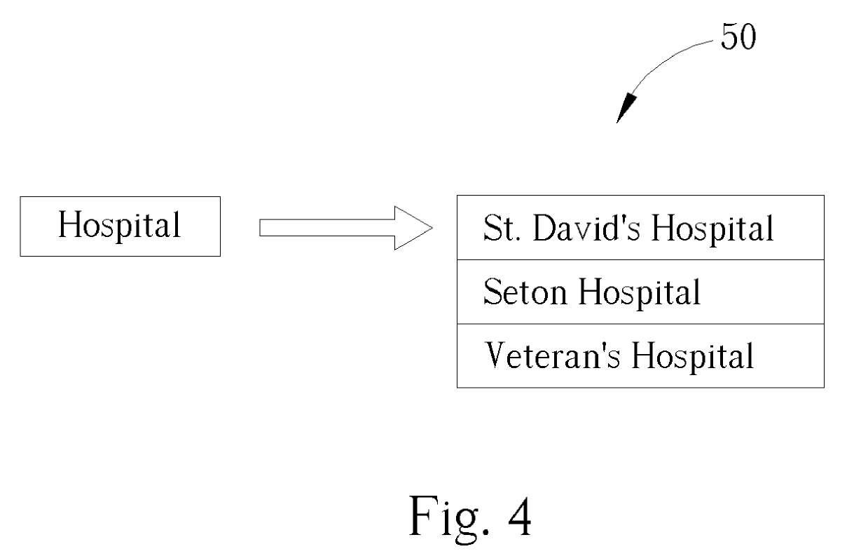

Please refer to FIG. 4. FIG. 4 is a diagram 50 illustrating multiple matches for each service listed in the LECAN database. Suppose that the user of the mobile station 10 wishes to dial a local hospital by selecting choice 3 on the LECAN display screen 40 shown in FIG. 3. There are three hospitals located near the current position of the mobile station 10: St. David's Hospital, Seton Hospital, and Veteran's Hospital. The order of the three hospitals can automatically be sorted according to distance from the mobile station 10 to the hospitals. When the user of the mobile station 10 chooses to call a hospital, the first hospital (St. David's Hospital) will automatically be called since it is the first choice. If, for some reason, the mobile station 10 is not able to connect to the first hospital within a predetermined period of time T, the mobile station 10 can be programmed to automatically call the second hospital (Seton Hospital). This feature allows the user of the mobile station 10 to quickly connect to a service even if a connection cannot be made with the primary phone number.

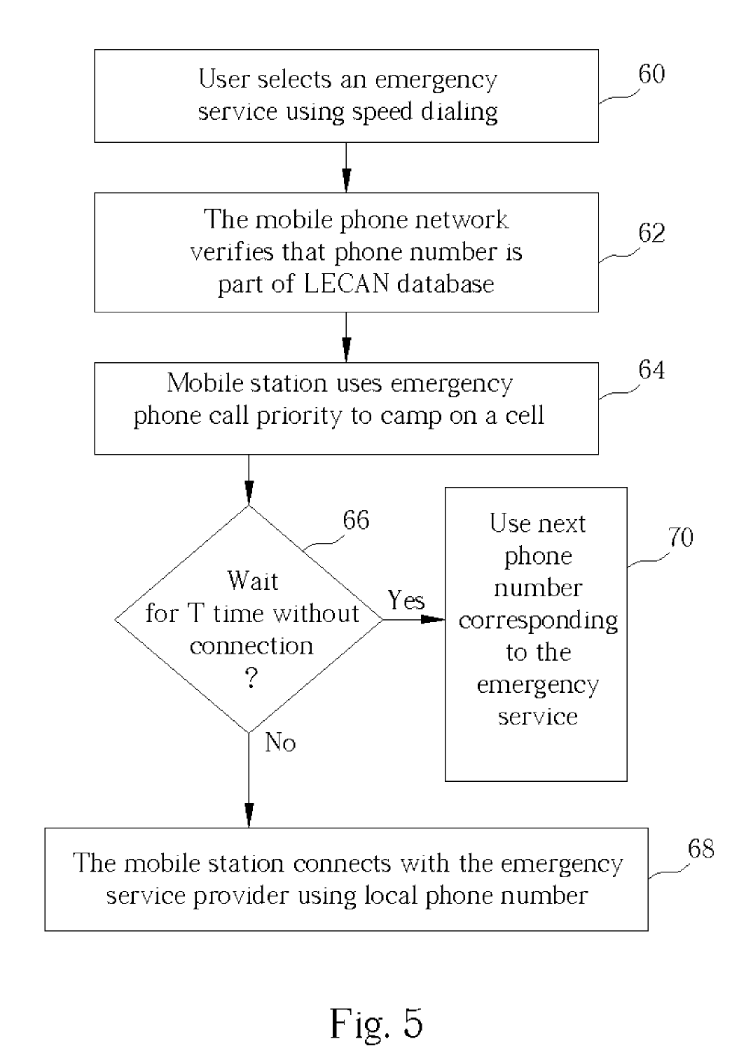

Please refer to FIG. 5. FIG. 5 is a flowchart illustrating connecting to local emergency services using speed dialing according to the present invention. Steps contained in the flowchart will be explained below.

Step 60: The user of the mobile station 10 selects an emergency service using the speed dialing shown on the LECAN display screen 40;

Step 62: The mobile phone network carrier verifies that the phone number of the emergency service is part of the LECAN database;

Step 64: The mobile station 10 uses emergency telephone call priority to camp on a cell;

Step 66: Determine if the mobile station 10 has been waiting for the predetermined period of time T without making a connection; if so, go to step 70; if not, go to step 68;

Step 68: The mobile station 10 connects with the emergency service provider using the local phone number dialed with the speed dialing interface; and

Step 70: Since no connection was made in the predetermined period of time T, the next phone number corresponding to the same type of emergency service is called.

Sometimes it is faster to directly drive to the emergency service provider (such as a hospital) than it is to wait for assistance (such as an ambulance) to arrive. For situations like this, the mobile station 10 can be configured such that the LECAN database information will display the relative location and distance between the current location and the chosen service provider. With other information databases supported by the mobile station 10, the routing information and driving instructions between the current location and the chosen service provider can be displayed on the display 14 of the mobile station 10.

Each LECAN database is bounded to a local area, and can be as small as a routing area or even smaller. Thus, when a user moves from one routing area to another, the LECAN database also needs to be updated. A Home LECAN is the LECAN table for the area where the mobile user's residence is and can be stored into the first nonvolatile memory 16. A LECAN database that belongs to an area other than the area covered by Home LECAN is called a Visiting LECAN. The Visiting LECAN can also be stored in the first nonvolatile memory 16, and needs to be updated when the user of the mobile station 10 moves to an area that is not covered by the Home LECAN and the current Visiting LECAN. In order to update the Visiting LECAN, the mobile station 10 will compare the location information of the Home LECAN and the Visiting LECAN to the current location information broadcast by the network.

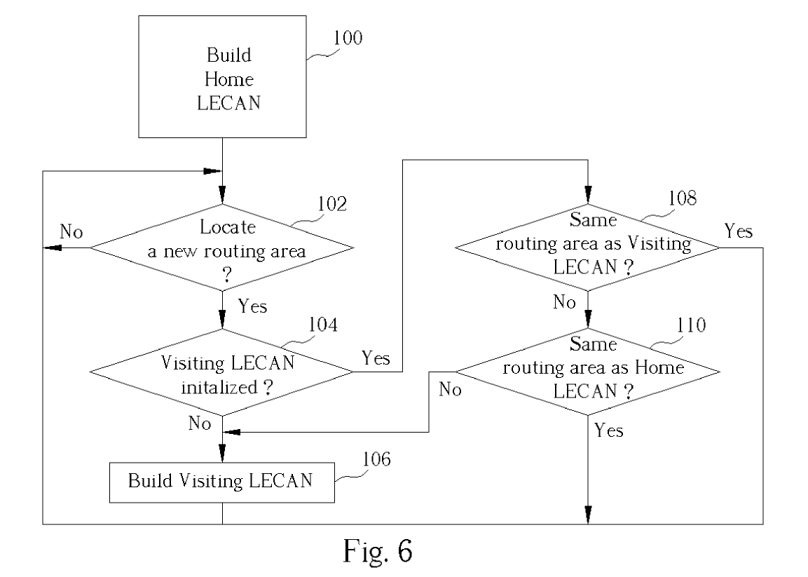

Please refer to FIG. 6. FIG. 6 is a flowchart illustrating building and updating the Home LECAN and the Visiting LECAN according to the present invention. Steps contained in the flowchart will be explained below.

Step 100: The mobile station 10 builds the Home LECAN for the routing area corresponding to the residence of the mobile user;

Step 102: Determine if a new routing area is detected; if so, go to step 104; if not, continue checking in step 102;

Step 104: Determine if the Visiting LECAN has been initialized; if so, go to step 108; if not, go to step 106;

Step 106: Since the Visiting LECAN has not been initialized, build the Visiting LECAN for the new routing area; go back to step 102;

Step 108: Determine if the new routing area is the same as the routing area for the Visiting LECAN; if so, go back to step 102; if not, go to step 110; and

Step 110: Determine if the new routing area is the same as the routing area for the Home LECAN; if so, go back to step 102; if not, go to step 106.

When the users dial the national emergency number of their home region on the mobile station 10, the LECAN display screen 40 shown in FIG. 3 will automatically appear on the display 14 of the mobile station 10 regardless of whether they are in the same country or a foreign country. Since the displayed characters on the LECAN display screen 40 can be translated between different languages, the mobile users will be allowed to customize the display language option to change the LECAN display screen 40 settings to use a different language. Since each record inside the LECAN database is displayed in order, the mobile users can use the record display order and move the display cursor to speed dial the local emergency call. Some mobile stations also provide a text-to-speech function or a speech synthesizer capability so they can read the options for the users. If the mobile station 10 further provides the voice recognition capability, the mobile users can first use a voice command to trigger the mobile station 10 to read out options on the LECAN display screen 40 and then use voice commands to activate the speed dialing directly to the local emergency service provider.

When the mobile station 10 needs to build or update the Home LECAN or Visiting LECAN, the mobile station 10 needs a way to download the LECAN database information. This can be accomplished in a variety of ways, depending on whether the current base station supports the LECAN service and whether the current base station is able to provide the contents of the LECAN database. Assume the mobile station 10 can issue an uplink request message to the base station. If the base station provides the LECAN service and provides the contents of the LECAN database, the base station will respond by sending messages to the mobile station 10 containing the LECAN database contents. If the base station provides the LECAN service, but does not provide the contents of the LECAN database, the mobile station 10 can dial a toll free number to download the LECAN database for the current Visiting LECAN. When the base station does not support the LECAN service, the base station will either not respond or will respond with an illegal service error message. In this case, exception handling schemes will be used, as discussed later.

We can assign a system broadcast message to include a field to indicate whether the network supports the LECAN service or not. If the network does support the LECAN service, then the methods outlined above can be used to download the LECAN database for the current Visiting LECAN. If the toll-free number can be used to download the LECAN database information, the system broadcast message indicates the toll-free number. On the other hand, instead of having the user of the mobile station 10 dial the toll-free number, the whole process of downloading updated LECAN database information can be automated and included in the communications protocol used by the mobile station 10.

Instead of constantly updating the LECAN database for the current Visiting LECAN, the global LECAN database can be derived offline and stored in the second nonvolatile memory 18 of the mobile station 10. When the mobile station 10 moves into a new routing area, the mobile station 10 can directly access the global LECAN database to derive local LECAN database information and the LECAN database information can be updated automatically.

If the network does not support the LECAN service, but the global LECAN database has already been stored in the second nonvolatile memory 18 of the mobile station 10, the global LECAN database can still be used to simulate the speed dialing process. In this case, the current location of the mobile station 10 would be matched with the emergency services in the global LECAN database which match that location. The Mobile Switch Center (MSC) will be used to detect calls hacked by users to illegally make the priority of basic calls change from basic telephone call priority to emergency telephone call priority. When such a scenario occurs, the MSC will report the attempt to the national security bureau and also charge the difference in the calling bill due to the higher priority to the user.

If none of the above approaches work for using the LECAN database to call local emergency services, some exception handling schemes can be used. If at any time the mobile user does not have local LECAN database information, the mobile user may try to dial the directory assistance telephone number such as 411 or 555-1212, or by dialing 0 for the operator. The mobile user can then be connected to the local emergency service directly, or can copy down the number and connect later by manually dialing the telephone number.

The present invention method may not work if the mobile user is in a foreign country that does not support the LECAN service and if the user does not have the local LECAN database information. With roaming support, the mobile station 10 that supports the LECAN database feature can display the local routing information: MCC+MNC+LAC, and pass this routing information back to the Home LECAN emergency center to download the current LECAN database.

Assume the user does not have the local LECAN information and the network does not support the LECAN feature, but the Visiting LECAN is available and with the same country code. If the mobile station 10 supports location detection, the LECAN database system of the mobile station 10 can display a workable LECAN menu with the distance between the Visiting LECAN and the local area. When the mobile user connects to the emergency service provider located at the Visiting LECAN area, the emergency service staff in the Visiting LECAN area can relay the emergency call back to the local emergency service provider based upon the location information provided by the mobile station 10.

Instead of using the speed dialing interface shown on the LECAN display screen 40 of FIG. 3, the present invention method can also upgrade the priority of basic calls that are manually dialed using the keypad 12 of the mobile station 10. For instance, if the user of the mobile station 10 has memorized the telephone number of the local police station, the user may manually dial the number instead of using the speed dial interface. The mobile station 10 will then consult the Home LECAN or the Visiting LECAN database information stored in the first nonvolatile memory 16 or the global LECAN database stored in the second nonvolatile memory 18 of the mobile station 10. If the dialed number matches the telephone number of an emergency service in one of the LECAN databases, the priority of the basic telephone call can be raised from basic telephone call priority to emergency telephone call priority.

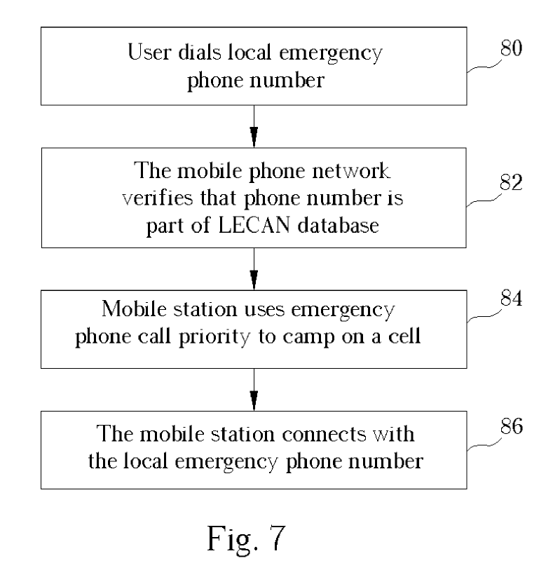

Please refer to FIG. 7. FIG. 7 is a flowchart illustrating upgrading priority of a call to a manually dialed telephone number according to the present invention. Steps contained in the flowchart will be explained below.

Step 80: The user of the mobile station 10 manually dials a local emergency phone number;

Step 82: The mobile phone network carrier verifies that the phone number of the emergency service is part of the LECAN database;

Step 84: The mobile station 10 uses emergency telephone call priority to camp on a cell; and

Step 86: The mobile station 10 connects with the emergency service provider using the local phone number manually dialed.

In contrast to the prior art, the present invention provides a method to give emergency telephone call priority to calls made to local emergency telephone numbers if the local emergency telephone number is part of the LECAN database. The number can be dialed using a speed dial interface designed for quickly accessing telephone numbers in the LECAN database or the number can be dialed manually. The present invention method allows users to bypass national emergency call centers that may be experiencing heavy call loads while at the same time receiving emergency telephone call priority for the emergency phone calls.

Those skilled in the art will readily observe that numerous modifications and alterations of the device may be made while retaining the teachings of the invention. Accordingly, the above disclosure should be construed as limited only by the metes and bounds of the appended claims.

1. A method of dialing a emergency telephone number using a mobile station, the mobile station having a database containing a plurality of Local Emergency Call Numbers (LECAN) corresponding to a specific geographic location, the method comprising:
displaying a list of local emergency services for the current geographic location;
selecting one of the local emergency services;
retrieving a first local emergency telephone number associated with the selected local emergency service;
upgrading connection priority of the mobile station to a mobile phone network from basic telephone call priority to emergency telephone call priority; and
making a first telephone connection with the first local emergency telephone number using the emergency telephone call priority.

2. The method of claim 1 wherein before making a first telephone connection, the method further comprises the mobile phone network verifying that the first local emergency telephone number is part of the LECAN database of the current geographic location.

3. The method of claim 1 wherein each LECAN database has a corresponding location ID based on one or more items selected from the group consisting of a Mobile Country Code (MCC), a Mobile Network Code (MNC), a Location Area Code (LAC), and a Routing Area Code (RAC).

4. The method of claim 3 wherein each LECAN database has a corresponding language associated with the LECAN database based on the location ID.

5. The method of claim 3 wherein the mobile station contains a first nonvolatile memory, and when the mobile station moves to a new location with a different MCC, MNC, LAC, or RAC, the mobile station loads a new LECAN database corresponding to the new location into the first nonvolatile memory.

6. The method of claim 5 wherein the mobile station downloads the new LECAN database into the first nonvolatile memory after moving to the new location.

7. The method of claim 5 wherein the mobile station copies the new LECAN database into the first nonvolatile memory from a second nonvolatile memory of the mobile station containing a list of global LECAN databases.

8. The method of claim 1 further comprising dialing a second local emergency telephone number associated with the selected local emergency service if the mobile station does not connect to the first local emergency telephone number within a predetermined period of time.

9. A method of upgrading priority of a local emergency call made with a mobile station, the mobile station having a database containing a plurality of Local Emergency CAII Numbers (LECAN) corresponding to a specific geographic location, the method comprising:
dialing a local emergency telephone number with the mobile station;
a mobile phone network verifying that dialed local emergency telephone number is part of the LECAN database of the current geographic location;
if the dialed local emergency telephone number is located in the LECAN database of the current geographic location, upgrading connection priority of the mobile station to the mobile phone network from basic telephone call priority to emergency telephone call priority; and
making a telephone connection with the local emergency telephone number using the emergency telephone call priority.

10. The method of claim 9 wherein each LECAN has a corresponding location ID based on one or more items selected from the group consisting of a Mobile Country Code (MCC), a Mobile Network Code (MNC), a Location Area Code (LAC), and a Routing Area Code (RAC).

11. The method of claim 10 wherein each LECAN has a corresponding language associated with the LECAN based on the location ID.

12. The method of claim 10 wherein the mobile station contains a first nonvolatile memory, and when the mobile station moves to a new location with a different MCC, MNC, LAC, or RAC, the mobile station loads a new LECAN database corresponding to the new location into the first nonvolatile memory.

13. The method of claim 12 wherein the mobile station downloads the new LECAN database into the first nonvolatile memory after moving to the new location.

14. The method of claim 12 wherein the mobile station copies the new LECAN database into the first nonvolatile memory from a second nonvolatile memory of the mobile station containing a list of global LECAN databases.
